(19) United States
(12) Patent Application Publication
(10) Pub. No.: US 2022/0163693 A1
(43) Pub. Date: May 26, 2022

(54) METHOD FOR DETERMINING A METEOROLOGICAL QUANTITY

(71) Applicant: UBIMET GmbH, Wien (AT)

(72) Inventors: Manfred SPATZIERER, Vienna (AT); Michael FASSNAUER, Vienna (AT)

(73) Assignee: UBIMET GmbH, Wien (AT)

(21) Appl. No.: 17/532,050

(22) Filed: Nov. 22, 2021

(30) Foreign Application Priority Data
Nov. 24, 2020 (AT) A51020/2020

(51) Int. Cl. G01W 1/10; G01W 1/06; G06N 3/08

(52) U.S. Cl. CPC G01W 1/10; G06N 3/08; G01W 1/06

(57) ABSTRACT

In a method for determining, in particular predicting, at least one meteorological quantity for describing a current and/or past and/or future weather situation using a data processing device, (a) first meteorological parameters obtained from first measurements are assigned to grid points of a first grid. In the method, (b) at least one setting parameter, which can be entered via an interface, in particular a user interface, is received, and (c) the at least one meteorological quantity is determined from the first meteorological parameters, dependent on the at least one setting parameter, by applying a first algorithm, wherein preferably, the determined meteorological quantity is output at a user interface and/or is transmitted by an electronic message sending device.

### CROSS REFERENCE TO RELATED APPLICATIONS

Applicant claims priority under 35 U.S.C. § 119 of Austrian Application No. A51020/2020 filed Nov. 24, 2020, the disclosure of which is incorporated by reference.

### BACKGROUND OF THE INVENTION

### 1. Field of the Invention

The invention relates to a method for determining, in particular predicting, at least one meteorological quantity for describing a current and/or past and/or future weather situation.

### 2. Description of the Related Art

Processing meteorological measuring data of a plurality of measuring stations and/or transferring them onto a grid, such that each grid point of the grid is assigned one or multiple meteorological parameter(s) is known from the prior art. These parameters describe past, current, or future weather situations. In order to describe the weather in a particular area, the nearest grid point was selected, and the parameters assigned to it for describing and/or predicting the weather were used. However, it has been shown that the flexibility and accuracy of such an approach are insufficient. Moreover, local conditions and/or subjective perceptions associated with the weather cannot be taken into account.

### SUMMARY OF THE INVENTION

The object of the present invention was to overcome the shortcomings of the prior art and to provide a method, by means of which a present data set of meteorological data with parameters distributed across grid points can be used flexibly for different purposes. In particular, a user of the system is to have the ability to make temporally and locally accurate assertions and/or predictions concerning a past, current, or future weather situation. In preferred embodiments, the method is to be characterized by configurability, so that meteorological quantities, or values derived therefrom, or information and/or the method steps of the method themselves can be adapted individually and/or to a specific—local, temporal, or subjective—situation.

This object is achieved by a method for determining, in particular predicting, at least one meteorological quantity for describing a current and/or past and/or future weather situation by means of a data processing device, in which

(a) first meteorological parameters obtained from first measurements are provided, wherein the first meteorological parameters are assigned to grid points of a first grid,
in that in the method

(b) at least one setting parameter, which can be entered via an interface, in particular a user interface, is received,

(c) the at least one meteorological quantity is determined from the first meteorological parameters, dependent on the at least one setting parameter, by applying an algorithm

wherein preferably, the determined meteorological quantity is output at a user interface and/or is transmitted by means of an electronic message sending device.

By entering the setting parameter, the user can make a situation-related decision on which information is determined and/or calculated from the first meteorological parameters—obtained from first measurements—, each of which is assigned to grid points of a first grid. The first meteorological parameters are preferably also available for different points in time in the past, so that, for example, a point-precise determination of the weather situation at a particular location (i.e., at a point) at a point in time in the past can be determined. This may be relevant, for example, for settling claims after an accident (possibly caused by fog, rain, snow, ice, wind, etc.) or destructive natural events. Using the first meteorological parameters, it is possible to calculate meteorological quantities e.g., also for random points located between the individual grid points, and for random points in time.

The present invention may also be referred to as a virtual weather station. Although the method underlying the virtual weather station is based on real, first measurements and first meteorological parameters obtained therefrom, the further method steps are carried out depending on a setting parameter, which serves as a specification for determining the meteorological quantity. The specification may be a location or time coordinate or a meteorological comparison parameter. The setting parameter is linked to the first parameters by means of the first algorithm.

The first (and second) grid is a spatial (e.g. two- or three-dimensional) grid, meaning the grid points correspond to different location coordinates of the area captured by the grid.

A preferred embodiment is characterized in that the at least one setting parameter comprises a time coordinate, preferably a point in time, and that, in step (c), the at least one meteorological quantity is determined for this time coordinate, wherein preferably, the time coordinate is in the past. By means of such a setting parameter, a meteorological quantity is determined for a particular time coordinate. The determination may be limited for a particular region or a location coordinate or be carried out for the entire region covered by the first grid. If no meteorological parameters are available for the predefined time coordinate, the meteorological quantity can be determined and/or estimated by interpolation, averaging, and/or consideration of the temporally closest parameters.

The method is advantageous, particularly when in step (b) and (c), a meteorological quantity for a point in time in the past or for a point (location coordinate), for which no data is available and which also does not correspond to any grid point, is calculated from the first meteorological parameters for the first time since their generation (from the first measurements).

A preferred embodiment is characterized in that the at least one setting parameter comprises a location coordinate, preferably a point, and that, in step (c), the at least one meteorological quantity is determined for this location coordinate, wherein preferably, the location coordinate is located between the grid points of the first grid. By predefining a location coordinate, it is possible to determine a meteorological quantity by means of the first algorithm, even if the location coordinate does not coincide with a grid point. Therefore, the weather can be calculated virtually for a particular point, although neither measurement data nor grid date (first meteorological parameters) are available for this specific point. This is preferably carried out by interpolation and/or averaging of the first parameters and/or by considering the parameters of the spatially closest grid points.

A preferred embodiment is characterized in that the at least one setting parameter comprises a characterization of at least one local condition, preferably concerning the vegetation, and/or the building development, and/or a wind- and/or sun-shading object, and/or the sea level, and/or the landscape form. In combination with the predefinition of a location coordinate, the additionally predefined local conditions result in that the meteorological quantity for this specific location can be determined even more precisely and in a more targeted manner. For example, a setting parameter including and/or describing a wall extending in the west-east direction results in that a wind strength of south or north winds—output as a meteorological quantity—is lower directly behind the wall than would be the case without the wall. The case is similar with a temperature (in particular around noon)—output as a meteorological quantity—if a group of trees casting a shadow e.g., south of the relevant location coordinate is entered as a setting parameter. Due to the possibility of individual setting parameters, a virtual weather station is created, meaning the meteorological quantity is modeled and adapted accordingly by means of an algorithm and/or a model.

A preferred embodiment is characterized in that the at least one setting parameter comprises at least one meteorological comparison parameter, which is obtained—independently of the first measurements—from observation and/or from at least one second measurement, wherein preferably, the comparison parameter describes the current weather situation. By such a comparison, the informative value of the determined meteorological quantity can be determined or improved for a particular location, at which the observations or second measurements were carried out. For this person, e.g., the algorithm and/or the meteorological quantity can be adapted. These comparisons may be carried out over a longer period of time and, in case of a self-learning algorithm, result in that the second meteorological quantity can be predicted increasingly well over time.

A preferred embodiment is characterized in that at least one situation parameter, which can be entered via an interface, in particular a user interface, is received,

wherein the situation parameter is assigned to the determined meteorological quantity,

and/or wherein the situation parameter is compared to the determined meteorological quantity,

and/or wherein, depending on the situation parameter, preferably depending on a deviation of the determined meteorological quantity from the situation parameter, the determined meteorological quantity is adapted and/or the algorithm is changed,

wherein the situation parameter preferably describes a current situation, in particular the weather situation or an action caused by the weather situation, in particular a de-icing operation or a road-clearing operation.

The situation parameter may serve as feedback for the system and ensure that the determination of the meteorological quantity or situations caused by the weather can be determined and/or predicted more accurately.

A preferred embodiment is characterized in that the meteorological quantity is determined for different points in time, and situation parameters for corresponding points in time are received. This enables a direct comparison or a direct link.

A preferred embodiment is characterized in that the at least one situation parameter comprises at least one meteorological parameter, which is obtained—independently of the first measurements—from observation and/or from at least one second measurement. Here, as well, the situation parameters serve as feedback for the system, and thereby, a virtual weather station can be “set up” for a particular location. The situation parameters in the form of meteorological parameters ensure that the “naked” first meteorological parameters gain “locality” by the actual parameters being determined by observation and/or second measurement at the particular location. Due to the resulting relationship and/or dependency between the first meteorological parameters and the situation parameters, it is possible to also adapt the algorithm, in order to be able to make locally precise assertions and/or predictions.

A preferred embodiment is characterized in that the at least one situation parameter comprises a parameter, which describes a physiological condition and/or a subjective perception of at least one person. This allows also taking weather-related subjective perceptions (weather sensitivity e.g., to foehn, weather changes, etc.) into account in addition to the meteorological quantity. Subjective perceptions can be processed advantageously especially if the values correlating thereto are comparable and/or if subjective perceptions are submitted by the same person and/or if subjective perceptions are captured and fed into the system under the same external circumstances (e.g., environmental parameters) and/or internal circumstances (e.g., state of activity of a person).

A preferred embodiment is characterized in that, depending on the determined meteorological quantity, a situation parameter, which preferably is a meteorological parameter and/or describes a physiological state and/or a subjective perception of at least one person, is determined or estimated—preferably by means of an algorithm or an assignment table—, wherein the situation parameter is preferably output at a user interface and/or transmitted by means of an electronic message sending device. A situation parameter cannot only be entered into the system but can also be determined or estimated by the system and optionally be output/transmitted.

A preferred embodiment is characterized in that a meteorological quantity is determined from the first meteorological parameters, independently of the at least one setting parameter, by applying an algorithm.

A preferred embodiment is characterized in that the meteorological quantity determined independently of the at least one setting parameter, and the meteorological quantity determined—according to step (c)—dependently on the at least one setting parameter are compared to one another, wherein preferably, depending on the deviation of the meteorological quantity determined independently of the at least one setting parameter from the meteorological quantity determined dependently on the at least one setting parameter, the algorithm is changed or adapted, and/or a value derived from both quantities is determined and preferably output to a user interface and/or is preferably transmitted by means of an electronic message sending device. With this embodiment, as well, the dependency of the algorithm on the setting parameter and thus the “naked” first meteorological parameters can be compared and/or correlated to the determined meteorological quantity.

A preferred embodiment is characterized in that

before or in step (c), second parameters—assigned to the grid points of a second grid—are created from the first parameters—assigned to the grid points of the first grid—, wherein the grid points of the second grid have a higher spatial resolution than the grid points of the first grid, wherein the creation of the second parameters is preferably carried out by means of interpolation and/or averaging of the first parameters, and

the at least one meteorological quantity is derived from the second meteorological parameters, preferably by means of interpolation and/or averaging.

By means of these steps, a particularly high spatial resolution can be achieved with relatively little computing efforts.

A preferred embodiment is characterized in that the first meteorological parameters comprise values of the temperature and/or the atmospheric pressure and/or the humidity and/or the wind strength and/or the wind direction and/or the precipitation and/or the cloudiness and/or the solar irradiance.

A preferred embodiment is characterized in that the at least one meteorological quantity comprises a value of the temperature and/or the atmospheric pressure and/or the humidity and/or the wind strength and/or the wind direction and/or the precipitation and/or the cloudiness and/or the solar irradiance.

A preferred embodiment is characterized in that the first meteorological parameters comprise current and/or past values and/or values to be expected in the future.

A preferred embodiment is characterized in that the algorithm is a configurable and/or self-learning algorithm. The algorithm is configurable, e.g., by the setting parameter. A self-learning algorithm is particularly preferred as it recognizes, based on setting parameters and/or setting parameters, which are entered e.g. over a period of time at different points in time (at an interface), how it has to change in order to determine the meteorological quantity as well as possible and accurately.

A preferred embodiment is characterized in that the data processing device is a portable device, preferably a smartphone or a tablet. The data processing may also be configured in the form of a device having a housing, e.g., in the form of a weather situation.

A preferred embodiment is characterized in that the data processing device comprises a measuring device for measuring at least one meteorological parameter. By this measuring device, the aforementioned second measurements can be carried out and preferably be fed directly—via an interface—to the method.

The object is also achieved by an algorithm for determining, in particular predicting, at least one meteorological quantity for describing a current and/or past and/or future weather situation, wherein the algorithm comprises the steps of a method according to the invention.

The object is also achieved by a data processing device and/or a computer program product stored on a data carrier, for determining, in particular predicting, at least one meteorological quantity for describing a current and/or past and/or future weather situation, wherein an algorithm according to the invention is stored in the data processing device and/or in the computer program product.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a flowchart of a first embodiment of the invention;

FIG. 2 is a flowchart of a second embodiment of the invention;

FIG. 3 is a flowchart of a third embodiment of the invention;

FIG. 4 shows a variant of the first embodiment; and

FIG. 5 shows a data processing device in the form of a smartphone and a data carrier.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

Finally, as a matter of form, it should be noted that for ease of understanding of the structure, elements are partially not depicted to scale and/or are enlarged and/or are reduced in size.

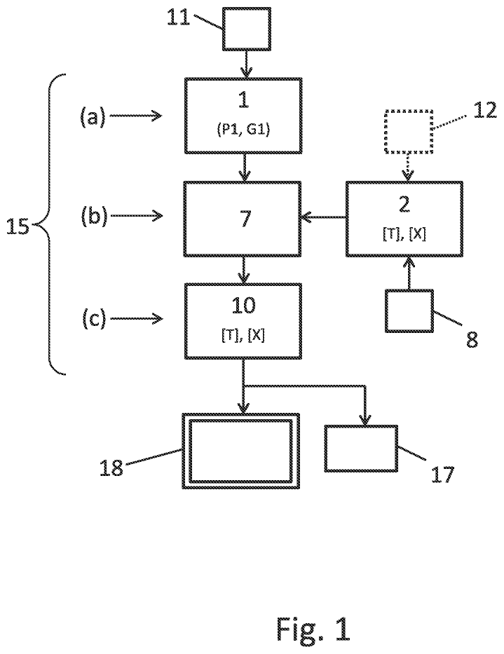

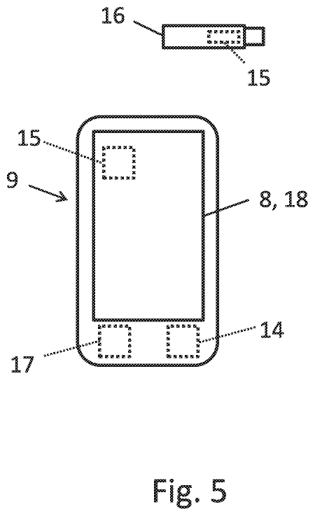

FIG. 1 shows an embodiment of the method according to the invention for determining, in particular predicting, at least one meteorological quantity 10 for describing a current and/or past and/or future weather situation. The method is carried out by means of a data processing device 9 (see FIG. 5).

Preceding the method are first measurements 11, which are carried out e.g. by a plurality of weather measuring stations—positioned at different locations—and/or by means of weather balloons and/or from satellite images and/or by means of radio signals, which are weakened to a greater or lesser extent by the atmosphere (by clouds, fog, precipitation, etc.).

From these first measurements 11, first meteorological parameters 1, each of which is assigned to grid points P1 of a grid G1, are obtained. The first meteorological parameters 1 may comprise values of the temperature and/or the atmospheric pressure and/or the humidity and/or the wind strength and/or the wind direction and/or the precipitation and/or the cloudiness and/or the solar irradiance. The first meteorological parameters 1 may comprise current and/or past values and/or to be expected in the future.

The invention is aimed both at a method and at a (superordinate) algorithm 15—see figures—for determining, in particular predicting, at least one meteorological quantity 10 for describing a current and/or past and/or future weather situation.

In step (a), first meteorological parameters 1 obtained from the first measurements 11 are provided, wherein the first meteorological parameters 1 are assigned to grid points P1 of a first grid G1. Preferably, each grid point P1 of the grid G1 is assigned at least one, preferably multiple first parameters (e.g. temperature, atmospheric pressure, humidity, etc.).

In step (b), at least one setting parameter 2, which can be entered via an interface 8, in particular a user interface, is received. The setting parameter may be entered e.g. by a user of the “virtual weather station”.

In step (c), the at least one meteorological quantity 10 is determined from the first meteorological parameters 1, dependent on the at least one setting parameter 2, by applying a first algorithm 7. The first algorithm 7 is preferably a configurable (by the setting parameters 2) and/or self-learning algorithm.

The at least one meteorological quantity 10 may comprise—like the first meteorological parameters—values of the temperature and/or the atmospheric pressure and/or the humidity and/or the wind strength and/or the wind direction and/or the precipitation and/or the cloudiness and/or the solar irradiance.

The thus determined meteorological quantity 10 is preferably output at a user interface 18, in particular a screen, and/or transmitted by means of an electronic message sending device 17 (email, short message, SMS, etc.).

As adumbrated in FIG. 1, the at least one setting parameter 2 may comprise a time coordinate T, preferably a point in time, wherein subsequently, in step (c), the at least one meteorological quantity 10 for this time coordinate T is determined. The time coordinate T may be in the past, in the present or in the future.

As also adumbrated in FIG. 1, the at least one setting parameter may comprise a location coordinate X, preferably a point, wherein subsequently, in step (c), the at least one meteorological quantity 10 for this location coordinate X is determined. In this regard, the location coordinate X may also be located between the grid points P1 of the first grid G1. This is preferably carried out by interpolation and/or averaging of the first parameters 1 and/or by considering the parameters 1 of the spatially closest grid points P1.

Additionally, the at least one setting parameter 2 may also comprise a characterization of at least one local condition, preferably concerning the vegetation, and/or the building development, and/or a wind- and/or sun-shading object, and/or the sea level, and/or the landscape form. The local conditions have a substantial influence on the local weather situation and can thus improve the assertion and/or prediction.

In a further preferred embodiment, the at least one setting parameter 2 may comprise at least one meteorological comparison parameter, which is obtained—independently of the first measurements 11—from observation and/or from at least one second measurement 12, wherein the comparison parameter preferably describes the current weather situation.

It is therefore possible—as described above—to enter multiple setting parameters (e.g., Time and/or location and/or local condition(s) and/or meteorological comparison parameter).

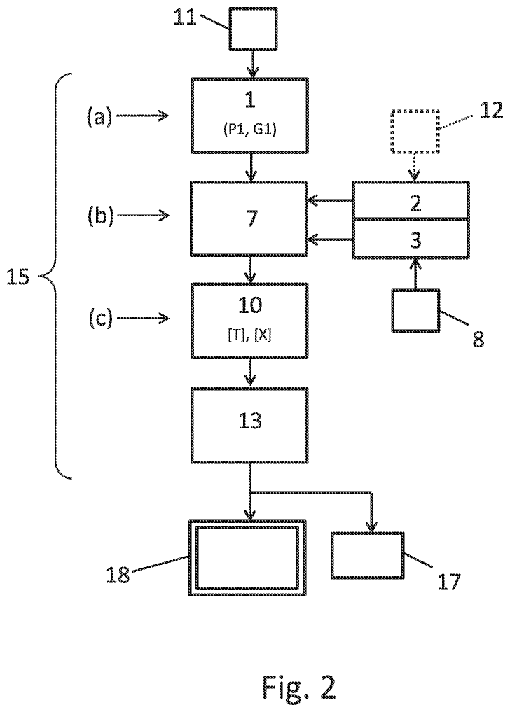

FIG. 2 shows an embodiment, in which at least one situation parameter 3, which can be entered via an interface 8, in particular a user interface, is received, wherein the situation parameter 3 can be assigned to the determined meteorological quantity 10 and/or compared to the determined meteorological quantity 10. It is also possible to adapt the meteorological quantity 10 and/or to change the first algorithm 7 depending on the situation parameter 3, preferably depending on a deviation of the determined meteorological quantity 10 from the situation parameter 3. The situation parameter 3 describes a current situation, in particular the weather situation or an action caused by the weather situation, in particular a de-icing operation (airport) or a road-clearing operation.

In this regard, the meteorological quantity 10 can be determined for different points in time, and situation parameters 3 for corresponding points in time can be received.

FIG. 2 shows that the at least one situation parameter 3 may comprise a meteorological parameter, which can be obtained—independently of the first measurements 11—from observation and/or from at least one second measurement 12.

However, the at least one situation parameter 3 may also comprise a parameter which describes a physiological state and/or a subjective perception of at least one person.

It is preferred if—not only situation parameters 3 are entered, but also—, depending on the determined meteorological quantity 10, a situation parameter 13, which preferably is a meteorological parameter and/or describes a physiological state and/or a subjective perception of at least one person, is determined or estimated—preferably by means of an algorithm or an assignment table. The situation parameter 13 may also be output at a user interface 18 and/or be transmitted by means of an electronic message sending device 17.

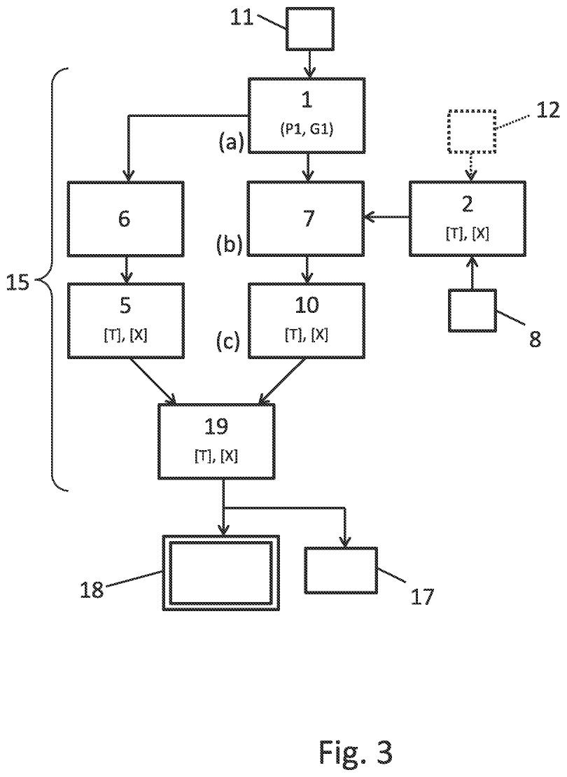

According to the embodiment of FIG. 3, a meteorological quantity 5 is determined from the first meteorological parameters 1, independently of the at least one setting parameter 2, by applying a second algorithm 6. The meteorological quantity 5 determined independently of the at least one setting parameter (2), and the meteorological quantity 10 determined—according to step (c)—dependently on the at least one setting parameter 2 can be compared to one another, wherein preferably, depending on the deviation of the meteorological quantity 5 determined independently of the at least one setting parameter 2 from the meteorological quantity 10 determined dependently on the at least one setting parameter 2, the first algorithm 7 is changed or adapted, and/or a value 19 derived from both quantities 5, 10 is determined and preferably output to a user interface 18 and/or is preferably transmitted by means of an electronic message sending device 17.

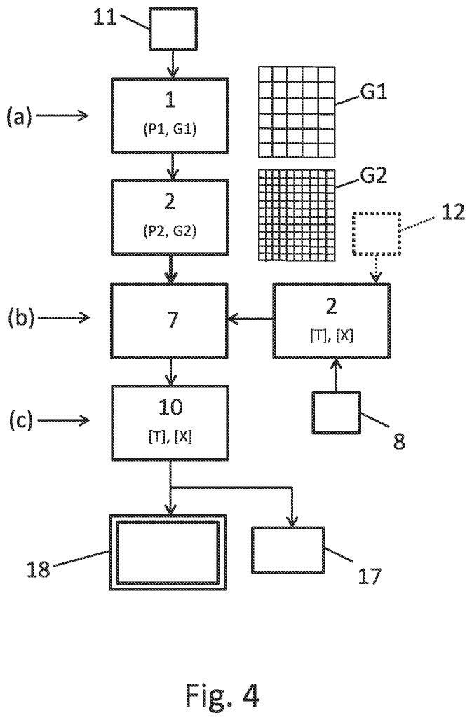

The embodiment shown in FIG. 4 is characterized in that before or in step (c), second parameters 4—assigned to the grid points P2 of a second grid G2—are created from the first parameters 1—assigned to the grid points P1 of the first grid G1—, wherein the grid points P2 of the second grid G2 have a higher spatial resolution than the grid points P1 of the first grid G1, wherein the creation of the second parameters 4 is preferably carried out by means of interpolation and/or averaging of the first parameters 1, and the at least one meteorological quantity 10 is derived from the second meteorological parameters 4, preferably by means of interpolation and/or averaging.

Lastly, FIG. 5 shows a data processing device 9 in the form of a portable device, preferably a smartphone or a tablet. It is preferred that the data processing device 9 comprises a measuring device 14 for measuring at least one meteorological parameter.

Lastly, the invention also relates to a data processing device 9 and/or a computer program product stored on a data carrier 16 (shown in FIG. 5 as a data stick), for determining, in particular predicting, at least one meteorological quantity 10 for describing a current and/or past and/or future weather situation, wherein the algorithm 15 is stored in the data processing device 9 and/or in the computer program product.

Although only a few embodiments of the present invention have been shown and described, it is to be understood that many changes and modifications may be made thereunto without departing from the spirit and scope of the invention.

### LIST OF REFERENCE NUMBERS

1 First meteorological parameters

2 Setting parameter

3 Situation parameter

4 Second meteorological parameters

5 Meteorological quantity

6 Algorithm

7 Algorithm

8 Interface

9 Data processing device

10 Meteorological quantity

11 First measurements

12 Second measurements

13 Situation parameter

14 Measuring device

15 Algorithm

16 Data carrier

17 Message sending device

18 User interface

19 Derived value

P1 Grid points

G1 First grid

P2 Grid points

G2 Second grid

T Time coordinate

X Location coordinate

What is claimed is:

1. A method for determining, in particular predicting, at least one meteorological quantity (10) for describing a current and/or past and/or future weather situation by means of a data processing device (9), in which
(a) first meteorological parameters (1) obtained from first measurements (11) are provided, wherein the first meteorological parameters (1) are assigned to grid points (P1) of a first grid (G1),
wherein, in the method
(b) at least one setting parameter (2), which can be entered via an interface (8), in particular a user interface, is received,
(c) the at least one meteorological quantity (10) is determined from the first meteorological parameters (1), dependent on the at least one setting parameter (2), by applying a first algorithm (7),
wherein preferably, the determined meteorological quantity (10) is output at a user interface (18) and/or is transmitted by means of an electronic message sending device (17).

2. The method according to claim 1, wherein the at least one setting parameter (2) comprises a time coordinate (T), preferably a point in time, and wherein, in step (c), the at least one meteorological quantity (10) is determined for this time coordinate (T), wherein preferably, the time coordinate (T) is in the past.

3. The method according to claim 1, wherein the at least one setting parameter comprises a location coordinate (X), preferably a point, and wherein, in step (c), the at least one meteorological quantity (10) is determined for this location coordinate (X), wherein preferably, the location coordinate (X) is located between the grid points (P1) of the first grid (G1).

4. The method according to claim 1, wherein the at least one setting parameter (2) comprises a characterization of at least one local condition, preferably concerning the vegetation, and/or the building development, and/or a wind- and/or sun-shading object, and/or the sea level, and/or the landscape form.

5. The method according to claim 1, wherein the at least one setting parameter (2) comprises at least one meteorological comparison parameter, which is obtained—independently of the first measurements (11)—from observation and/or from at least one second measurement (12), wherein preferably, the comparison parameter describes the current weather situation.

6. The method according to claim 1, wherein at least one situation parameter (3), which can be entered via an interface (8), in particular a user interface, is received,
wherein the situation parameter (3) is assigned to the determined meteorological quantity (10),
and/or wherein the situation parameter (3) is compared to the determined meteorological quantity (10),
and/or wherein, depending on the situation parameter (3), preferably depending on a deviation of the determined meteorological quantity (10) from the situation parameter (3), the determined meteorological quantity (10) is adapted and/or the first algorithm (7) is changed,
wherein preferably, the situation parameter (3) describes a current situation, in particular the weather situation or an action caused by the weather situation, in particular a de-icing operation or a road-clearing operation.

7. The method according to claim 6, wherein the meteorological quantity (10) is determined for different points in time, and situation parameters (3) for corresponding points in time are received.

8. The method according to claim 6, wherein the at least one situation parameter (3) comprises at least one meteorological parameter, which is obtained—independently of the first measurements (11)—from observation and/or from at least one second measurement (12).

9. The method according to claim 6, wherein the at least one situation parameter (3) comprises a parameter, which describes a physiological condition and/or a subjective perception of at least one person.

10. The method according to claim 1, wherein, depending on the determined meteorological quantity (10), a situation parameter (13), which preferably is a meteorological parameter and/or describes a physiological state and/or a subjective perception of at least one person, is determined or estimated—preferably by means of an algorithm or an assignment table—, wherein preferably, the situation parameter (13) is output at a user interface (18) and/or transmitted by means of an electronic message sending device (17).

11. The method according to claim 1, wherein a meteorological quantity (5) is determined from the first meteorological parameters (1), independently of the at least one setting parameter (2), by applying a second algorithm (6).

12. The method according to claim 11, wherein the meteorological quantity (5) determined independently of the at least one setting parameter (2), and the meteorological quantity (10) determined—according to step (c)—dependently on the at least one setting parameter (2) are compared to one another, wherein preferably, depending on the deviation of the meteorological quantity (5) determined independently of the at least one setting parameter (2) from the meteorological quantity (10) determined dependently on the at least one setting parameter (2), the first algorithm (7) is changed or adapted, and/or a value (19) derived from both quantities (5, 10) is determined and preferably output to a user interface (18) and/or is preferably transmitted by means of an electronic message sending device (17).

13. The method according to claim 1, wherein
before or in step (c), second parameters (4)—assigned to the grid points (P2) of a second grid (G2)—are created from the first parameters (1)—assigned to the grid points (P1) of the first grid (G1)—, wherein the grid points (P2) of the second grid (G2) have a higher spatial resolution than the grid points (P1) of the first grid (G1), wherein preferably, the creation of the second parameters (4) is carried out by means of interpolation and/or averaging of the first parameters (1), and the at least one meteorological quantity (10) is derived from the second meteorological parameters (4), preferably by means of interpolation and/or averaging.

14. The method according to claim 1, wherein the first meteorological parameters (1) comprise values of the temperature and/or the atmospheric pressure and/or the humidity and/or the wind strength and/or the wind direction and/or the precipitation and/or the cloudiness and/or the solar irradiance
and/or wherein the at least one meteorological quantity (10) comprises a value of the temperature and/or the atmospheric pressure and/or the humidity and/or the wind strength and/or the wind direction and/or the precipitation and/or the cloudiness and/or the solar irradiance.

15. The method according to claim 1, wherein the first meteorological parameters (1) comprise current and/or past values and/or values to be expected in the future.

16. The method according to claim 1, wherein the algorithm (7) is a configurable and/or self-learning algorithm.

17. The method according to claim 1, wherein the data processing device (9) is a portable device, preferably a smartphone or a tablet.

18. The method according to claim 1, wherein the data processing device (9) comprises a measuring device (14) for measuring at least one meteorological parameter.

19. An algorithm (15) for determining, in particular predicting, at least one meteorological quantity (10) for describing a current and/or past and/or future weather situation, wherein the algorithm comprises the steps of the method according to claim 1.

20. A data processing device (9) and/or a computer program product stored on a data carrier (16) for determining, in particular predicting, at least one meteorological quantity (10) for describing a current and/or past and/or future weather situation, wherein the algorithm (15) according to claim 19 is stored in the data processing device (9) and/or in the computer program product.
